(19) United States
(12) Patent Application Publication
(10) Pub. No.: US 2002/0024299 A1
(43) Pub. Date: Feb. 28, 2002

(54) Chip-type light-emitting device

(76) Inventor: Tadahiro Okazaki, Kyoto-shi (JP)

Correspondence Address: ARENT FOX KINTNER PLOTKIN & KAHN, 1050 CONNECTICUT AVENUE, N.W., SUITE 600, WASHINGTON, DC, 20036, US

(21) Appl. No.: 09/924,114

(22) Filed: Aug. 8, 2001

(30) Foreign Application Priority Data
Aug. 9, 2000 (JP) 2000-240754

(51) Int. Cl. H01J 1/62

(52) U.S. Cl. 313/512

(57) ABSTRACT

In a chip-type light-emitting device, terminal electrodes are formed at both ends of the surface of a chip substrate, and a light-emitting element and a diode for protecting the light-emitting element at least against a reverse voltage are connected in parallel between the terminal electrodes. The chip substrate is fitted with a reflective cover formed by integrally forming a reflecting portion that permits the light from the light-emitting element to exit from the chip-type light-emitting device in a predetermined direction and a light-shielding portion that shields the diode from the light entering the chip-type light-emitting device from outside. Alternatively, a light-shielding member is provided so as to cover the diode so that the diode is shielded from the light striking it. In either way, a leak current through the diode can be prevented.

### BACKGROUND OF THE INVENTION

1. Field of the Invention

The present invention relates to a chip-type light-emitting device, and more particularly to a chip-type light-emitting device provided with a light-emitting element and a diode for protecting the light-emitting element against a reverse voltage.

2. Description of the Prior Art

Light-emitting elements used in chip-type light-emitting devices are typically made of compound semiconductors such as those based on GaAs, GaP, GaN, and the like. These compound semiconductors, however, are vulnerable to a reverse voltage applied thereto, and thus layers made of such compound semiconductors are prone to destruction. In particular, GaN-based compound semiconductors, which are characterized by a low permissible reverse voltage of about 50 V and a high band gap energy, need to be driven with an operating voltage higher than usual, and therefore applying an alternating-current voltage thereto leads to destruction of light-emitting elements or deterioration of their characteristics. In addition, application of a high voltage such as static electricity, even if it is a forward voltage as low as about 150 V, is likely to result in destruction of light-emitting elements.

Conventionally, to prevent destruction of light-emitting elements resulting from application of a reverse voltage or static electricity thereto as described above, chip-type light-emitting devices are provided with protection elements such as diodes. FIG. 6 shows a perspective view of such a conventional chip-type light-emitting device, and FIG. 7 shows a sectional view thereof taken along line B-B shown in FIG. 6. At both ends of a chip substrate 4 along its length are formed terminal electrodes 3 and 3′ respectively, with the terminal electrodes 3 or 3′ at each end connected together by a through hole 6. On the surface of the terminal electrode 3 that is formed at one end of and on the obverse surface of the chip substrate 4, a wire bonding portion 31 and a chip bonding portion 32 are formed. The wire bonding portion 31 is connected to the p-side electrode of a light-emitting element 1 by a bonding wire, and on the chip bonding portion 32 is bonded the n-side electrode of a diode 2. On the surface of the terminal electrode 3′ that is formed at the other end of and on the obverse surface of the chip substrate 4, wire bonding portions 33 and 34 are formed. The wire bonding portion 33 is connected to the n-side electrode of the light-emitting element 1 by a bonding wire, and the wire bonding portion 34 is connected to the p-side electrode of the diode 2 by a bonding wire. Around the obverse surface of the chip substrate 4 is provided a reflective case 5, which reflects upward the light emitted from the light-emitting element sideward. The light-emitting element 1, the diode 3, and the bonding wires provided inside the reflective case 5 are sealed in translucent sealing resin 7.

In a conventional chip-type light-emitting device like this, in which a light-emitting element 1 and a diode 2 are connected in parallel between terminal electrodes 3 and 3′, the light emitted from the light-emitting element 1 inevitably strikes the diode 2. This causes a leak current to flow through the diode 2 and thereby makes the current flowing through the light-emitting element 1 insufficient. In addition, light striking the diode 2 from outside the chip-type light-emitting device also causes a leak current, albeit to a smaller degree.

### SUMMARY OF THE INVENTION

An object of the present invention is to provide a chip-type light-emitting device that, despite being provided with a light-emitting element and a diode, is free from a leak current flowing through the diode so that a sufficient amount of current flows through the light-emitting element.

To achieve the above object, according to one aspect of the present invention, in a chip-type light-emitting device provided with a chip substrate, terminal electrodes formed at both ends of the surface of the chip substrate, a light-emitting element connected between the terminal electrodes, and a diode connected in parallel with the light-emitting element between the terminal electrodes so as to protect the light-emitting element at least against a reverse voltage, the chip substrate is fitted with a reflective case formed by forming integrally a reflecting portion that permits the light from the light-emitting element to exit from the chip-type light-emitting device in a predetermined direction and a light-shielding portion that shields the diode from the light entering the chip-type light-emitting device from outside. This arrangement prevents a leak current from flowing through the diode. Moreover, this arrangement permits the diode to be covered with the light-shielding portion simultaneously when the chip substrate is fitted with the reflective case.

Here, preferably, the reflecting portion is a cavity formed in the reflective case so as to surround the light-emitting element with an opening formed in the direction in which the light from the light-emitting element is permitted to exit, and the light-shielding portion is another cavity formed in the reflective case so as to surround the diode.

According to another aspect of the present invention, in a chip-type light-emitting device comprising a chip substrate, terminal electrodes formed at both ends of the surface of the chip substrate, a light-emitting element connected between the terminal electrodes, and a diode connected in parallel with the light-emitting element between the terminal electrodes so as to protect the light-emitting element at least against a reverse voltage, a light-shielding member is provided so as to cover the diode so that the diode is shielded from the light striking it. This arrangement prevents a leak current from flowing through the diode. As a result, in this chip-type light-emitting device according to the present invention, a sufficient amount of current flows through the light-emitting element, without any loss in the amount of light emitted therefrom.

Here, preferably, the light-shielding member is a box-shaped member that is open at the bottom thereof, or a sealing member made of opaque resin in which the diode is sealed.

### BRIEF DESCRIPTION OF THE DRAWINGS

This and other objects and features of the present invention will become clear from the following description, taken in conjunction with the preferred embodiments with reference to the accompanying drawings in which:

FIG. 1 is a perspective view of a chip-type light-emitting device embodying the invention;

FIG. 2 is a sectional view taken along line A-A shown in FIG. 1;

FIG. 3 is a sectional view of another chip-type light-emitting device embodying the invention;

FIG. 4 is a sectional view of still another chip-type light-emitting device embodying the invention;

FIGS. 5A to 5D are diagrams showing an example of the manufacturing process of the chip-type light-emitting device shown in FIG. 4;

FIG. 6 is a perspective view of a conventional chip-type light-emitting device; and

FIG. 7 is a sectional view taken along line B-B shown in FIG. 6.

### DESCRIPTION OF THE PREFERRED EMBODIMENTS

The inventor of the present invention has been studying how to prevent, in a case where a light-emitting element and a diode are provided side by side, the leak current that inevitably flows through the diode as a result of the light emission by the light-emitting element, and has conceived the present invention on the basis of the idea, which is apparently simple but has never been proposed hitherto, that such a leak current is prevented by shielding the diode from the light striking it.

Specifically, one of the distinctive features of the present invention lies in the provision of a light-shielding member that shields the diode from the light striking it. With this arrangement, even in a case where a diode and a light-emitting element are provided side by side, no leak current flows through the diode, and thus no loss in the amount of light emitted from the light-emitting element results from insufficient current flowing therethrough.

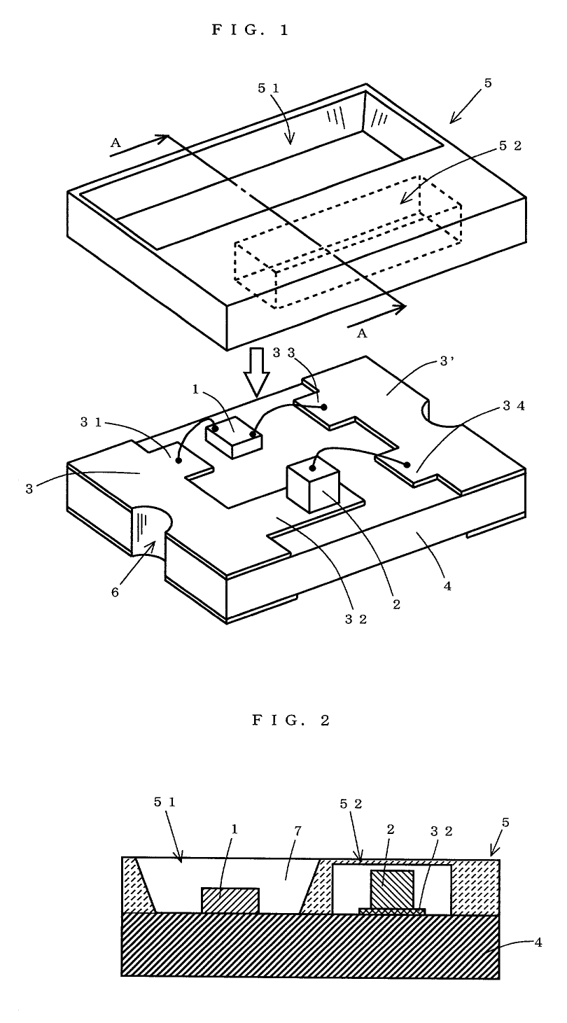

FIG. 1 shows a chip-type light-emitting device embodying the invention. The positions of and the interconnection among the terminal electrodes 3 and 3′, the light-emitting element 1, and the diode 2 arranged on the chip substrate 4 are the same as in the conventional chip-type light-emitting device shown in FIG. 6, and therefore the explanations related to these will not be repeated. In addition, a reflective case 5 is provided so as to cover the chip substrate 4. The reflective case 5 is composed of two portions that are formed integrally, namely a reflecting portion 51 that reflects upward the light from the light-emitting element 1 and a light-shielding portion 52 that shields the diode 2 from the light striking it from outside. The reflective case 5 is fitted on the chip substrate 4 in such a way that the reflecting portion 51 surrounds the light-emitting element 1 and the light-shielding portion 52 surrounds the diode 2. Then, the inside of the reflecting portion 51, including the light-emitting element 1, is sealed with translucent sealing resin 7. FIG. 2 shows a sectional view taken along line A-A shown in FIG. 1.

As shown in FIG. 2, the light shielding portion 52 is a cavity formed in the reflective case 5 so as to cover the diode 2, the bonding wires, and the bonding portions. Preferably, the depth of the cavity 52 is so determined that the bonding wires do not touch the ceiling surface thereof, and the width of the cavity 52 is so determined that the diode 2 does not touch the side surfaces thereof. The cavity 52 may be formed in any shape, and its shape is determined appropriately according to the shapes and the relative positions of the diode 2, the bonding wires, and the bonding portions. In the chip-type light-emitting device shown in FIGS. 1 and 2, the reflecting portion has an opening formed at its top to make light exit upward from the chip-type light-emitting device; however, in a case where light is made to exit sideward, the opening is formed at the side of the reflecting portion.

The reflective case, composed of the light-shielding portion and the reflecting portion formed integrally, may be produced in any manner as long as it permits the light from the light-emitting element to exit in a predetermined direction and shields the diode from the light striking it; for example, it is produced by molding a white liquid crystal polymer or the like by the use of a metal mold. The reflective case can be fitted on the chip substrate by heating or pressing by the use of a conventionally known adhesive such as epoxy adhesive.

The diode used in the present invention may be of any conventionally known type, a particularly preferred type being a constant-voltage diode (Zener diode) for the following reasons. When a reverse voltage is applied to the light-emitting element, a current flows through the Zener diode, with the result that, in effect, almost no voltage is applied to the light-emitting element. When a high voltage resulting from static electricity is applied to the light-emitting element, as long as the voltage is higher than the Zener voltage, it is discharged through the Zener diode, with the result that the light-emitting element is saved from destruction.

The light-emitting element used in the present invention may be of any type, examples including blue light-emitting elements such as those based on GaN and the like, and red or green light-emitting elements such as those based on GaAs, AlGaAs, AlGaInP, InP, and the like. Among these, a type particularly preferred in a chip-type light-emitting device embodying the invention is a GaN-based light-emitting element, because it is so produced as to have a structure in which a p-type layer and an n-type layer are laid on top of each other on an insulating substrate such as one made of sapphire, and thus accumulates static electricity easily.

Examples of the translucent sealing resin with which the inside of the reflecting portion, including the light-emitting element, is sealed include, to name a few, epoxy resin, unsaturated polyester resin, silicone resin, and urea-melamine resin. Among these, a particularly preferred material is epoxy resin for its good translucent and other properties. Epoxy resin of any type can be used here as long as it contains two or more epoxy groups in each molecule and is intended for use as material for epoxy resin molding, examples including: glycidyl ether type epoxy resin such as phenol-novolac type, ortho-cresol-novolac type, bisphenol A type, bisphenol F type, bisphenol S type, or hydrogenated bisphenol A type epoxy resin; glycidyl ester type epoxy resin obtained through reaction with epichlorohydrin of a polybasic acid such as phthalic acid or dimer acid; glycidyl amine type epoxy resin obtained through reaction with epichlorohydrin of a polyamine such as diaminodiphenyl methane or isocyanuric acid; and alicyclic epoxy resin obtained through oxidation of olefin linkage with a peracid such as peracetic acid. These materials can be used singly or as a mixture of two or more of them. Preferably, any of these types of epoxy resin needs to be purified sufficiently and, irrespective of whether it is liquid or solid at ordinary temperature, look as transparent as possible when liquefied.

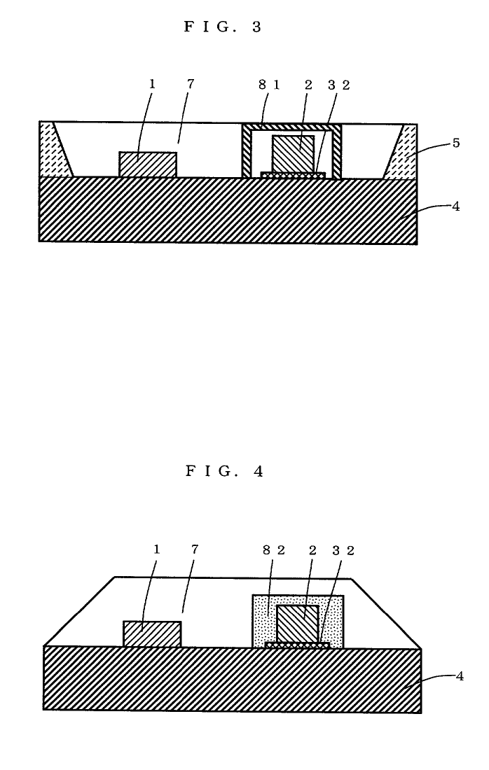

FIG. 3 shows another chip-type light-emitting device embodying the invention. FIG. 3 is a sectional view of this chip-type light-emitting device. Here, a box-shaped light-shielding member 81 that is formed separately from the reflective case 5 is fitted on the chip substrate 4 so as to cover the diode 2 and the bonding wires. Then, the recess surrounded by the reflective case 5, including the light-emitting element 1 and the light-shielding member 81, is sealed with translucent sealing resin 7. This arrangement also permits the diode 2 to be shielded from the light striking it, and thereby prevents a leak current from flowing through the diode 2. The light-shielding member 81, which is provided separately from the reflective case 5, may be formed in any shape as long as it completely covers at least the diode 2, and its shape is determined appropriately according to the shape and mounting position of the diode 2. The light-shielding member 81 may be made of any material as long as it does not transmit light, a particularly preferred material being opaque resin, because it is easy to shape. Here, when the light-shielding member 81 is fitted so as to cover the diode 2, it is necessary to see to it that it does not touch the diode 2 or the bonding wires. The chip-type light-emitting device shown in FIG. 3 has the reflective case 5 fitted thereon; however, the arrangement of this embodiment is applicable also to a so-called mold type arrangement having no reflective case 5.

FIG. 4 shows still another chip-type light-emitting device embodying the invention. In the chip-type light-emitting device shown in FIG. 4, first the diode 2 is sealed in a sealing member (light-shielding member) 82 made of opaque resin, and then the sealing member 82 itself is in turn sealed, together with the light-emitting element 1, in translucent sealing resin 7 such as epoxy resin. This arrangement also permits the diode 2 to be shielded from the light striking it, and thereby prevents a leak current from flowing through the diode 2.

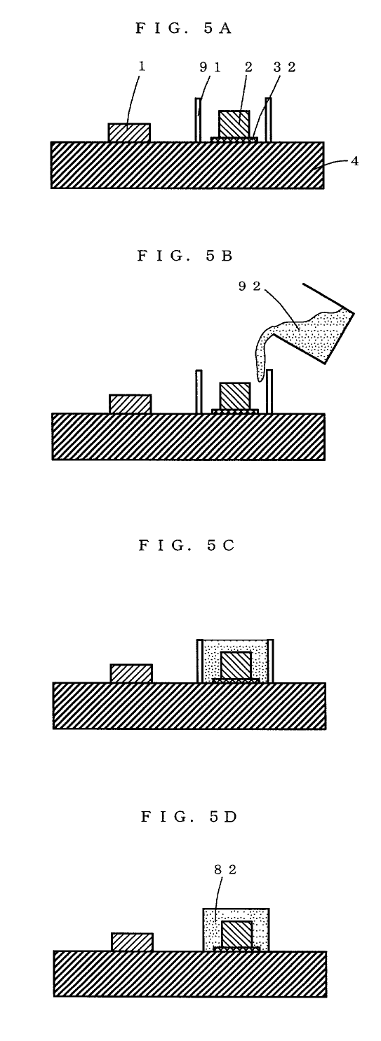

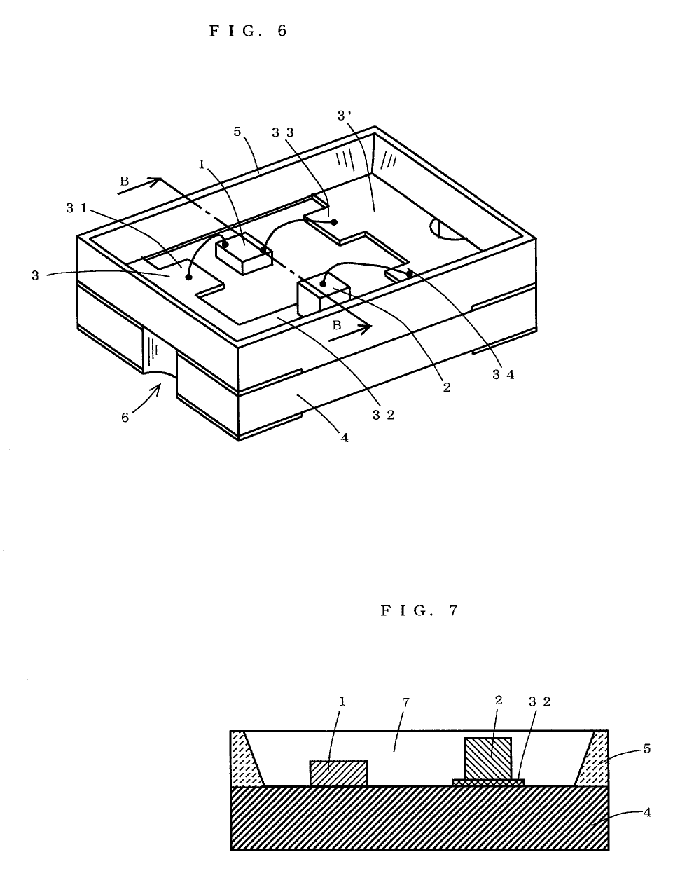

A chip-type light-emitting device like this can be manufactured by any conventionally known method. For example, as shown in FIGS. 5A to 5D, first the portions to be sealed in opaque resin, i.e. the diode 2, the bonding wires, the bonding portions 32, and the like, are enclosed in a frame 91 (FIG. 5A), and opaque thermosetting resin 92 is poured inside the frame 91 (FIG. 5B). Then, after the thermosetting resin 92 is heated so as to be cured (FIG. 5C), the frame 91 is removed to complete the sealing member 82 (FIG. 5D). In the following steps, although not illustrated, the chip substrate 4 having the sealing member 82 formed thereon is mounted on a metal mold having a recess formed therein so as to correspond to the shape of the sealing resin 7, and the sealing resin 7 is formed by transfer molding to obtain the chip-type light-emitting device shown in FIG. 4. In the manufacturing process shown in FIGS. 5A to 5D, the shielding member 82 is formed by pouring the resin 92 inside the frame 91 that has been formed beforehand; however, it is also possible to form the shielding member 82 without forming the frame 92 by pouring highly viscous resin directly over the portions to be sealed in, such as the diode 2, and then curing the resin.

The sealing member 82 here may be made of any type of resin as long as it is opaque, including even translucent resin made opaque by being mixed with a pigment or dye, a preferred type being black resin. Examples of such resin include epoxy resin, unsaturated polyester, methacrylic resin, polyurethane, silicone resin, ε-caprolactam, and diethylene glycol. Among these, colorless, transparent types such as epoxy resin, unsaturated polyester, and methacrylic resin are used after being mixed with a colorant so as to be made opaque.

Transfer molding is normally performed under the following conditions: at molding temperatures of 140 to 160° C., at pressure of 400 to 1,200 N/cm², and for a molding time of 1 to 5 minutes.

When a chip-type light-emitting device embodying the invention is used, for example, in a state mounted on a circuit board, first the chip-type light-emitting device is placed on the circuit board in such a way that the terminal electrodes of the former make contact with the conductor pattern formed on the latter, then conducting adhesive such as cream solder is applied to the terminal electrodes and the conductor pattern, and then, using a reflow furnace, the cream solder is heated so as to be melted.

What is claimed is:

1. A chip-type light-emitting device comprising a chip substrate, terminal electrodes formed at both ends of a surface of the chip substrate, a light-emitting element connected between the terminal electrodes, and a diode connected in parallel with the light-emitting element between the terminal electrodes, the diode serving to protect the light-emitting element at least against a reverse voltage,
wherein the chip substrate is fitted with a reflective case formed by forming integrally a reflecting portion that permits light from the light-emitting element to exit from the chip-type light-emitting device in a predetermined direction and a light-shielding portion that shields the diode from light entering the chip-type light-emitting device from outside.

2. A chip-type light-emitting device as claimed in claim 1,
wherein the reflecting portion is a cavity formed in the reflective case so as to surround the light-emitting element with an opening formed in the direction in which the light from the light-emitting element is permitted to exit, and the light-shielding portion is another cavity formed in the reflective case so as to surround the diode.

3. A chip-type light-emitting device comprising a chip substrate, terminal electrodes formed at both ends of a surface of the chip substrate, a light-emitting element connected between the terminal electrodes, and a diode connected in parallel with the light-emitting element between the terminal electrodes, the diode serving to protect the light-emitting element at least against a reverse voltage,
wherein a light-shielding member is provided so as to cover the diode so that the diode is shielded from light striking the diode.

4. A chip-type light-emitting device as claimed in claim 3,
wherein the light-shielding member is a box-shaped member that is open at a bottom thereof.

5. A chip-type light-emitting device as claimed in claim 3,
wherein the light-shielding member is a sealing member made of opaque resin in which the diode is sealed.
